(19) United States
(12) Patent Application Publication
(10) Pub. No.: US 2023/0327194 A1
(43) Pub. Date: Oct. 12, 2023

(54) SOLID ELECTROLYTE MATERIAL AND BATTERY

(71) Applicant: Panasonic Intellectual Property Management Co., Ltd., Osaka (JP)

(72) Inventors: KOSEI OHURA, Osaka (JP); TOMOYASU YOKOYAMA, Osaka (JP)

(21) Appl. No.: 18/332,999

(22) Filed: Jun. 12, 2023

Related U.S. Application Data
(63) Continuation of application No. PCT/JP2021/038345, filed on Oct. 18, 2021.

(30) Foreign Application Priority Data
Dec. 25, 2020 (JP) 2020-217888
May 27, 2021 (JP) 2021-089635
Jun. 10, 2021 (JP) 2021-097450
Jun. 14, 2021 (JP) 2021-098934

(51) Int. Cl. H01M 10/0562

(52) U.S. Cl. CPC H01M 10/0562; H01M 2300/008

(57) ABSTRACT

A solid electrolyte material is represented by the compositional formula (1): Li₁₋ₐAlₐX₁₊₂ₐ, wherein 0<a<0.5 (excluding a=0.5) is satisfied, and X is at least one selected from the group consisting of Cl, Br, and I. Another solid electrolyte material includes Li, Al, and X′, here, X′ is at least one selected from the group consisting of Cl, Br, and I and includes a first crystal phase belonging to P2₁/c and a second crystal phase different from the first crystal phase.

### BACKGROUND

### 1. Technical Field

The present disclosure relates to a solid electrolyte material and a battery.

### 2. Description of the Related Art

Japanese Unexamined Patent Application Publication No. 57-103270 discloses LiAlI₄ as a raw material for a lithium-oxide-halide solid-phase electrolyte.

### SUMMARY

One non-limiting and exemplary embodiment provides a solid electrolyte material suitable for improving lithium ion conductivity.

In one general aspect, the techniques disclosed here feature a solid electrolyte material represented by the following compositional formula (1): Li₁₋ₐAlₐX₁₊₂ₐ (1). Here, 0<a<0.5 (excluding a=0.5) is satisfied, and X is at least one selected from the group consisting of Cl, Br, and I.

The present disclosure provides a solid electrolyte material suitable for improving lithium ion conductivity.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIG. 1 is a cross-sectional view of a battery 1000 according to a third embodiment;

FIG. 2 is a schematic view of a compression molding dies 300 used for evaluation of the ion conductivity of a solid electrolyte material;

FIG. 3 is a graph showing a cole-cole plot obtained by impedance measurement of the solid electrolyte material of Example 1;

FIG. 4 is a graph showing X-ray diffraction patterns of the solid electrolyte materials of Examples 1 to 6; and

FIG. 5 is a graph showing the initial discharge characteristics of the battery of Example 1.

### DETAILED DESCRIPTIONS

Embodiments of the present disclosure will now be described with reference to the drawings.

### First Embodiment

The solid electrolyte material of a first embodiment is represented by the following compositional formula (1):

Li₁₋ₐAlₐX₁₊₂ₐ (1).

Here, 0<a<1 (excluding a=0.5) is satisfied, and X is at least one selected from the group consisting of Cl, Br, and I.

The solid electrolyte material according to the first embodiment is a solid electrolyte material suitable for improving lithium ion conductivity. The solid electrolyte material according to the first embodiment has, for example, a high lithium ion conductivity. Accordingly, the solid electrolyte material according to the first embodiment can be used for obtaining a battery having excellent charge and discharge characteristics. An example of the battery is an all solid secondary battery.

Here, an example of the high lithium ion conductivity is, for example, 4×10⁻⁶ S/cm or more at around room temperature. The solid electrolyte material according to the first embodiment can have an ion conductivity of, for example, 4×10⁻⁶ S/cm or more.

In the compositional formula (1), when 0<a is satisfied, LiI having a low ion conductivity is unlikely to be formed. When a<1 is satisfied, since the amount of Li, which is an ion conductive species, is increased, the ion conductivity is improved.

The solid electrolyte material according to the first embodiment may contain elements that are unavoidably mixed. Examples of the elements are hydrogen, nitrogen, and oxygen. These elements may be present in the raw material powders of the solid electrolyte material or in the atmosphere for manufacturing or storing the solid electrolyte material. The amount of the elements unavoidably mixed in the solid electrolyte material according to the first embodiment is, for example, 1 mol % or less.

In order to enhance the ion conductivity of the solid electrolyte material, in the compositional formula (1), 0<a<0.5 may be satisfied, 0.01≤a≤0.48 may be satisfied, or 0.01≤a≤0.45 may be satisfied. In order to further enhance the ion conductivity of the solid electrolyte material, 0.2≤a≤0.48 may be satisfied, 0.2≤a≤0.45 may be satisfied, or 0.33≤a≤0.45 may be satisfied.

In order to enhance the ion conductivity of the solid electrolyte material, in the compositional formula (1), 0.5<a<1 may be satisfied, and 0.55≤b≤0.67 may be satisfied. In order to enhance the ion conductivity of the solid electrolyte material, X may include I, or X may be I.

The solid electrolyte material according to the first embodiment may be crystalline or amorphous.

The shape of the solid electrolyte material according to the first embodiment is not limited. Examples of the shape are needle, spherical, and oval spherical shapes. The solid electrolyte material according to the first embodiment may be a particle. The solid electrolyte material according to the first embodiment may be formed so as to have a pellet shape or a planar shape.

For example, when the solid electrolyte material according to the first embodiment has a particulate (e.g., spherical) shape, the solid electrolyte material according to the first embodiment may have a median diameter of 0.1 μm or more and 100 μm or less. The median diameter means the particle size at which the accumulated deposition is 50% in a volume-based particle size distribution. The volume-based particle size distribution is measured with, for example, a laser diffraction measurement apparatus or an image analyzer.

The solid electrolyte material according to the first embodiment may have a median diameter of 0.5 μm or more and 10 μm or less. Consequently, the solid electrolyte material according to the first embodiment has a higher ion conductivity. Furthermore, the solid electrolyte material according to the first embodiment and another material such as an active material can be well dispersed.

The solid electrolyte material according to the first embodiment may have a median diameter smaller than that of the active material. Consequently, the solid electrolyte material according to the first embodiment and the active material can be well dispersed.

### Second Embodiment

A second embodiment will now be described. Description overlapping with the solid electrolyte material of the first embodiment may be omitted as appropriate.

The solid electrolyte material of the second embodiment may be a solid electrolyte material containing Li, Al, and X′. Here, X′ is at least one selected from the group consisting of Cl, Br, and I.

The solid electrolyte material according to the second embodiment includes a first crystal phase belonging to P2₁/c, and a second crystal phase that is different from the first crystal phase.

The solid electrolyte material according to the second embodiment has a high lithium ion conductivity. Accordingly, the solid electrolyte material according to the second embodiment can be used for obtaining a battery having excellent charge and discharge characteristics.

The first crystal phase may have a composition represented by LiAlX′₄. The LiAlX′₄ has a crystal structure belonging to P2₁/c.

In order to enhance the ion conductivity of the solid electrolyte material, the second crystal phase may have a crystal structure belonging to Fm-3m.

The second crystal phase may have a composition represented by LiX′. The LiX′ has a crystal structure belonging to Fm-3m.

In order to enhance the ion conductivity of the solid electrolyte material, the second crystal phase may have a crystal structure belonging to C2/m or P2₁/c.

The second crystal phase may have a composition represented by AlX′₃. The AlCl₃ has a crystal structure belonging to C2/m. AlBr₃ and AlI₃ each have a crystal structure belonging to P2₁/c.

The solid electrolyte material according to the second embodiment may have a first crystal phase, a second crystal phase, and a third crystal phase different from the first crystal phase and the second crystal phase.

In order to enhance the ion conductivity of the solid electrolyte material, X′ may include I, or X′ may be I.

The shape of the solid electrolyte material according to the second embodiment is not limited. Examples of the shape are needle, spherical, and oval spherical shapes. The solid electrolyte material according to the second embodiment may be a particle. The solid electrolyte material according to the second embodiment may be formed so as to have a pellet shape or a planar shape.

For example, when the solid electrolyte material according to the second embodiment has a particulate (e.g., spherical) shape, the solid electrolyte material according to the second embodiment may have a median diameter of 0.1 μm or more and 100 μm or less.

The solid electrolyte material according to the second embodiment may have a median diameter of 0.5 μm or more and 10 μm or less. Consequently, the solid electrolyte material according to the second embodiment has a higher ion conductivity. Furthermore, the solid electrolyte material according to the second embodiment and another material such as an active material can be well dispersed.

The solid electrolyte material according to the second embodiment may have a median diameter smaller than that of the active material. Consequently, the solid electrolyte material according to the second embodiment and the active material can be well dispersed.

### Third Embodiment

A third embodiment will now be described. The matters described in the first embodiment or the second embodiment may be omitted as appropriate.

The third embodiment will describe a battery.

The battery according to the third embodiment includes a positive electrode, an electrolyte layer, and a negative electrode. The electrolyte layer is disposed between the positive electrode and the negative electrode. The electrolyte layer contains 20 mol % or more of a compound represented by the following compositional formula (2):

Li_{1-b}Al_{b}I_{+2b} (2).

Here, 0<b<1 is satisfied.

In the batter according to the third embodiment, the electrolyte layer contains 20 mol % or more of the compound represented by the compositional formula (2). Consequently, the electrolyte layer in the battery according to the third embodiment can realize a high lithium ion conductivity. Such an electrolyte layer can have an ion conductivity higher than that of, for example, an electrolyte layer consisting of LiI. Accordingly, the battery according to the third embodiment has excellent charge and discharge characteristics.

The battery according to the third embodiment may be an all solid battery.

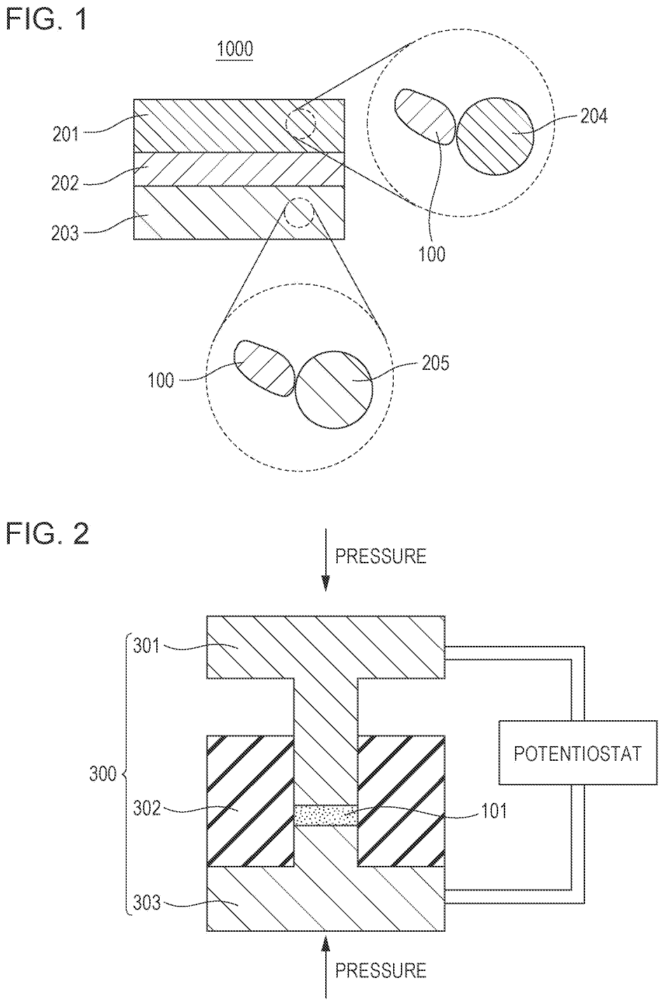

FIG. 1 is a cross-sectional view of a battery 1000 according to the third embodiment.

The battery 1000 includes a positive electrode 201, an electrolyte layer 202, and a negative electrode 203. The electrolyte layer 202 is disposed between the positive electrode 201 and the negative electrode 203.

The positive electrode 201 contains a positive electrode active material particle 204 and a solid electrolyte particle 100.

The negative electrode 203 contains a negative electrode active material particle 205 and a solid electrolyte particle 100.

The positive electrode 201 contains a material that can occlude and release metal ions such as lithium ions. The material is, for example, a positive electrode active material (e.g., the positive electrode active material particle 204).

Examples of the positive electrode active material are a lithium-containing transition metal oxide, a transition metal fluoride, a polyanionic material, a fluorinated polyanionic material, a transition metal sulfide, a transition metal oxyfluoride, a transition metal oxysulfide, and a transition metal oxynitride. Examples of the lithium-containing transition metal oxide are Li(Ni,Co,Mn)O₂, Li(Ni,Co,Al)O₂, and LiCoO₂.

In the present disclosure, “(A,B,C)” means “at least one selected from the group consisting of A, B, and C”.

The positive electrode active material particle 204 may have a median diameter of 0.1 μm or more and 100 μm or less. When the positive electrode active material particle 204 has a median diameter of 0.1 μm or more, the positive electrode active material particle 204 and the solid electrolyte particle 100 can be well dispersed in the positive electrode 201. Consequently, the charge and discharge characteristics of the battery 1000 are improved. When the positive electrode active material particle 204 has a median diameter of 100 μm or less, the lithium diffusion speed in the positive electrode active material particle 204 is improved. Consequently, the battery 1000 can operate at a high output.

The positive electrode active material particle 204 may have a median diameter larger than that of the solid electrolyte particle 100. Consequently, the positive electrode active material particle 204 and the solid electrolyte particle 100 can be well dispersed.

In order to increase the energy density and the output of the battery 1000, in the positive electrode 201, the ratio of the volume of the positive electrode active material particle 204 to the sum of the volume of the positive electrode active material particle 204 and the volume of the solid electrolyte particle 100 may be 0.30 or more and 0.95 or less.

In order to increase the energy density and the output of the battery 1000, the positive electrode 201 may have a thickness of 10 μm or more and 500 μm or less.

The electrolyte layer 202 contains 20 mol % or more of a compound represented by the compositional formula (2). The electrolyte layer 202 may contain the compound represented by the compositional formula (2) in an amount of exceeding 20 mol % or exceeding 25 mol % or in an amount of 30 mol % or more. The electrolyte layer 202 may contain the compound represented by the compositional formula (2) as a main component. Here, the main component means a component of which the molar ratio is the highest among the components constituting the electrolyte layer 202. In order to enhance the charge and discharge characteristics of the battery 1000, the electrolyte layer 202 may contain 50 mol % or more of the compound. In order to enhance the charge and discharge characteristics of the battery 1000, the electrolyte layer 202 may contain 90 mol % or more of the compound. The electrolyte layer 202 may consist of the compound.

In order to enhance the charge and discharge characteristics of the battery 1000, the electrolyte layer 202 may contain the solid electrolyte material according to the first embodiment. That is, the compound represented by the compositional formula (2) may be the solid electrolyte material according to the first embodiment.

In order to enhance the charge and discharge characteristics of the battery 1000, in the compositional formula (2), 0<b<0.5 may be satisfied, 0.01≤b≤0.48 may be satisfied, 0.01≤b≤0.33 may be satisfied, 0.2≤b≤0.48 may be satisfied, 0.2≤b≤0.45 may be satisfied, or 0.33≤b≤0.45 may be satisfied.

In order to enhance the charge and discharge characteristics of the battery 1000, in the compositional formula (2), 0.5≤b≤1 may be satisfied, or 0.55≤b≤0.67 may be satisfied.

Hereinafter, the compound represented by the compositional formula (2) is referred to as first solid electrolyte material. The solid electrolyte material that is different from the first solid electrolyte material is referred to as second solid electrolyte material.

The electrolyte layer 202 may contain not only the first solid electrolyte material but also the second solid electrolyte material. The first solid electrolyte material and the second solid electrolyte material may be uniformly dispersed in the electrolyte layer 202. A layer made of the first solid electrolyte material and a layer made of the second solid electrolyte material may be stacked along the stacking direction of the battery 1000.

The electrolyte layer 202 may have a thickness of 1 μm or more and 1000 μm or less. When the electrolyte layer 202 has a thickness of 1 μm or more, the positive electrode 201 and the negative electrode 203 are unlikely to be short-circuited. When the electrolyte layer 202 has a thickness of 1000 μm or less, the battery 1000 can operate at a high output.

The negative electrode 203 contains a material that can occlude and release metal ions such as lithium ions. The material is, for example, a negative electrode active material (e.g., the negative electrode active material particle 205).

Examples of the negative electrode active material are a metal material, a carbon material, an oxide, a nitride, a tin compound, and a silicon compound. The metal material may be a single metal or an alloy. Examples of the metal material are a lithium metal and a lithium alloy. Examples of the carbon material are natural graphite, coke, graphitizing carbon, carbon fibers, spherical carbon, artificial graphite, and amorphous carbon. From the viewpoint of capacity density, suitable examples of the negative electrode active material are silicon (i.e., Si), tin (i.e., Sn), a silicon compound, and a tin compound.

The negative electrode active material particle 205 may have a median diameter of 0.1 μm or more and 100 μm or less. When the negative electrode active material particle 205 has a median diameter of 0.1 μm or more, the negative electrode active material particle 205 and the solid electrolyte particle 100 can be well dispersed in the negative electrode 203. Consequently, the charge and discharge characteristics of the battery 1000 are improved. When the negative electrode active material particle 205 has a median diameter of 100 μm or less, the lithium diffusion speed in the negative electrode active material particle 205 is improved. Consequently, the battery 1000 can operate at a high output.

The negative electrode active material particle 205 may have a median diameter larger than that of the solid electrolyte particle 100. Consequently, the negative electrode active material particle 205 and the solid electrolyte particle 100 can be well dispersed.

In order to increase the energy density and the output of the battery 1000, in the negative electrode 203, the ratio of the volume of the negative electrode active material particle 205 to the sum of the volume of the negative electrode active material particle 205 and the volume of the solid electrolyte particle 100 may be 0.30 or more and 0.95 or less.

In order to increase the energy density and the output of the battery 1000, the negative electrode 203 may have a thickness of 10 μm or more and 500 μm or less.

At least one selected from the group consisting of the positive electrode 201, the electrolyte layer 202, and the negative electrode 203 may contain the second solid electrolyte material for the purpose of enhancing the ion conductivity, chemical stability, and electrochemical stability.

The second solid electrolyte material may be a halide solid electrolyte.

Examples of the halide solid electrolyte are Li₂MgZ1₄, Li₂FeZ1₄, Li(Ga,In)Z1₄, and Li₃(Al,Ga,In)Z1₆. Here, Z1 is at least one selected from the group consisting of F, Cl, Br, and I. Another example is LiAlZ2₄. Here, Z2 is at least one selected from the group consisting of F, Cl, and Br.

Other examples of the halide solid electrolyte are compounds represented by LiₚMe_{q}YᵣZ3₆. Here, p+m′q+3r=6 and r>0 are satisfied. Me is at least one element selected from the group consisting of metal elements and metalloid elements excluding Li and Y. The value of m′ represents the valence of Me. The “metalloid elements” are B, Si, Ge, As, Sb, and Te. The “metal elements” are all elements included in Groups 1 to 12 of the periodic table (however, hydrogen is excluded) and all elements included in Groups 13 to 16 in the periodic table (however, B, Si, Ge, As, Sb, Te, C, N, P, O, S, and Se are excluded). Z3 is at least one selected from the group consisting of F, Cl, Br, and I. From the viewpoint of the ion conductivity of the halide solid electrolyte, Me may be at least one selected from the group consisting of Mg, Ca, Sr, Ba, Zn, Sc, Al, Ga, Bi, Zr, Hf, Ti, Sn, Ta, and Nb.

The second solid electrolyte material may be a sulfide solid electrolyte.

Examples of the sulfide solid electrolyte are Li₂S—P₂S₅, Li₂S—SiS₂, Li₂S—B₂S₃, Li₂S—GeS₂, Li_{3.25}Ge_{0.25}P_{0.75}S₄, and Li₁₀GeP₂Si₂.

The second solid electrolyte material may be an oxide solid electrolyte.

Examples of the oxide solid electrolyte are:
(i) an NASICON-type solid electrolyte, such as LiTi₂(PO₄)₃ or its element substitute;
(ii) a perovskite-type solid electrolyte, such as (LaLi)TiO₃;
(iii) an LISICON-type solid electrolyte, such as Li₁₄ZnGe₄O₁₆, Li₄SiO₄, LiGeO₄, or its element substitute;
(iv) a garnet-type solid electrolyte, such as Li₇La₃Zr₂O₁₂ or its element substitute; and
(v) Li₃PO₄ or its N-substitute.

The second solid electrolyte material may be an organic polymer solid electrolyte.

Examples of the organic polymer solid electrolyte are a polymer compound and a compound of a lithium salt. The polymer compound may have an ethylene oxide structure. A polymer compound having an ethylene oxide structure can contain a large amount of a lithium salt and can therefore further enhance the ion conductivity.

Examples of the lithium salt are LiPF₆, LiBF₄, LiSbF₆, LiAsF₆, LiSO₃CF₃, LiN(SO₂CF₃)₂, LiN(SO₂C₂F₅)₂, LiN(SO₂CF₃)(SO₂C₄F₉), and LiC(SO₂CF₃)₃. One lithium salt selected from these salts may be used alone, or a mixture of two or more lithium salts selected from these salts may be used.

At least one selected from the group consisting of the positive electrode 201, the electrolyte layer 202, and the negative electrode 203 may contain a nonaqueous electrolyte liquid, a gel electrolyte, or an ionic liquid for the purpose of facilitating the transfer of lithium ions and improving the output characteristics of the battery.

The nonaqueous electrolyte liquid includes a nonaqueous solvent and a lithium salt dissolved in the nonaqueous solvent.

Examples of the nonaqueous solvent are a cyclic carbonate solvent, a chain carbonate solvent, a cyclic ether solvent, a chain ether solvent, a cyclic ester solvent, a chain ester solvent, and a fluorine solvent. Examples of the cyclic carbonate solvent are ethylene carbonate, propylene carbonate, and butylene carbonate. Examples of the chain carbonate solvent are dimethyl carbonate, ethyl methyl carbonate, and diethyl carbonate. Examples of the cyclic ether solvent are tetrahydrofuran, 1,4-dioxane, and 1,3-dioxolane. Examples of the chain ether solvent are 1,2-dimethoxyethane and 1,2-diethoxyethane. An example of the cyclic ester solvent is γ-butyrolactone. An example of the chain ester solvent is methyl acetate. Examples of the fluorine solvent are fluoroethylene carbonate, methyl fluoropropionate, fluorobenzene, fluoroethyl methyl carbonate, and fluorodimethylene carbonate. One nonaqueous solvent selected from these solvents may be used alone. Alternatively, a mixture of two or more nonaqueous solvents selected from these solvents may be used.

Examples of the lithium salt are LiPF₆, LiBF₄, LiSbF₆, LiAsF₆, LiSO₃CF₃, LiN(SO₂CF₃)₂, LiN(SO₂C₂F₅)₂, LiN(SO₂CF₃)(SO₂C₄F₉), and LiC(SO₂CF₃)₃. One lithium salt selected from these salts may be used alone. Alternatively, a mixture of two or more lithium salts selected from these salts may be used. The concentration of the lithium salt is, for example, 0.5 mol/L or more and 2 mol/L or less.

As the gel electrolyte, a polymer material impregnated with a nonaqueous electrolyte liquid may be used. Examples of the polymer material are polyethylene oxide, polyacrylonitrile, polyvinylidene fluoride, polymethyl methacrylate, and a polymer having an ethylene oxide bond.

Examples of the cation included in the ionic liquid are:
(i) an aliphatic chain quaternary salt, such as tetraalkylammonium and tetraalkylphosphonium;
(ii) aliphatic cyclic ammonium, such as pyrrolidiniums, morpholiniums, imidazoliniums, tetrahydropyrimidiniums, piperaziniums, and piperidiniums; and
(iii) a nitrogen-containing heterocyclic aromatic cation, such as pyridiniums and imidazoliums.

Examples of the anion included in the ionic liquid are PF₆⁻, BF₄⁻, SbF₆⁻, AsF₆⁻, SO₃CF₃⁻, N(SO₂CF₃)₂⁻, N(SO₂C₂F₅)₂⁻, N(SO₂CF₃)(SO₂C₄F₉)⁻, and C(SO₂CF₃)₃⁻.

The ionic liquid may contain a lithium salt.

At least one selected from the group consisting of the positive electrode 201, the electrolyte layer 202, and the negative electrode 203 may contain a binder for the purpose of improving the adhesion between individual particles.

Examples of the binder are polyvinylidene fluoride, polytetrafluoroethylene, polyethylene, polypropylene, an aramid resin, polyamide, polyimide, polyamideimide, polyacrylonitrile, polyacrylic acid, polyacrylic acid methyl ester, polyacrylic acid ethyl ester, polyacrylic acid hexyl ester, polymethacrylic acid, polymethacrylic acid methyl ester, polymethacrylic acid ethyl ester, polymethacrylic acid hexyl ester, polyvinyl acetate, polyvinylpyrrolidone, polyether, polyether sulfone, hexafluoropolypropylene, styrene butadiene rubber, and carboxymethyl cellulose. A copolymer can also be used as the binder. Examples of such the binder are copolymers of two or more materials selected from the group consisting of tetrafluoroethylene, hexafluoroethylene, hexafluoropropylene, perfluoroalkyl vinyl ether, vinylidene fluoride, chlorotrifluoroethylene, ethylene, propylene, pentafluoropropylene, fluoromethyl vinyl ether, acrylic acid, and hexadiene. A mixture of two or more selected from the above-mentioned materials may be used as the binder.

At least one selected from the positive electrode 201 and the negative electrode 203 may contain a conductive assistant for the purpose of enhancing the electron conductivity.

Examples of the conductive assistant are:
(i) graphites, such as natural graphite and artificial graphite;
(ii) carbon blacks, such as acetylene black and Ketjen black;
(iii) conductive fibers, such as carbon fibers and metal fibers;
(iv) carbon fluoride;
(v) metal powders, such as aluminum;
(vi) conductive whiskers, such as zinc oxide and potassium titanate;
(vii) a conductive metal oxide, such as titanium oxide; and
(viii) a conductive polymer compound, such as polyanion, polypyrrole, and polythiophene.

In order to reduce the cost, the conductive assistant of the above (i) or (ii) may be used.

Examples of the shape of the battery according to the third embodiment are coin type, cylindrical type, square type, sheet type, button type, flat type, and laminated type.

### Method for Manufacturing First Solid Electrolyte Material

A compound represented by the compositional formula (2), the first solid electrolyte material, is manufactured by, for example, the following method.

For example, two or more iodide raw material powders are mixed so as to have a desired composition.

As an example, when the target composition is LiAlI₄, a LiI raw material powder and an AlI₃ raw material powder (i.e., two iodide raw material powders) are mixed such that the molar ratio of LiI:AlI₃ is approximately 1:1. The raw material powders may be mixed at a molar ratio adjusted in advance so as to offset a composition change that may occur in the synthesis process.

An increase in LiI decreases the value of b in the compositional formula (2). An increase in AlI₃ increase the value of b.

As the raw materials, Li metal, Al metal, and I₂ may be used.

Raw material powders in a mixture are mechanochemically reacted with each other in a mixing apparatus such as a planetary ball mill to obtain a reaction product. That is, raw material powders are reacted with each other by a mechanochemical milling method. The reaction product may be heat-treated in vacuum or in an inert atmosphere. Alternatively, a mixture of the raw material powders may be heat-treated in vacuum or in an inert gas atmosphere to obtain a reaction product.

The first solid electrolyte material represented by the compositional formula (2) is obtained by these methods. By the same method, the solid electrolyte material according to the first embodiment represented by the compositional formula (1) can also be obtained.

### EXAMPLES

The present disclosure will now be described in more detail with reference to Examples.

### Example 1

### Production of Solid Electrolyte Material

LiI and AlI₃ were prepared as raw material powders such that the molar ratio of LiI:AlI₃ was 1:1 in an argon atmosphere having a dew point of −60° C. or less (hereinafter, referred to as “dry argon atmosphere”). These raw material powders were pulverized and mixed in a mortar. Thus, a mixture powder was obtained. The mixture powder was milled with a planetary ball mill at 500 rpm for 12 hours. Thus, a solid electrolyte material powder of Example 1 was obtained. The solid electrolyte material of Example 1 had a composition represented by LiAlI₄.

The Li content per unit weight of the solid electrolyte material of Example 1 was measured by atomic absorption analysis. The Al content and I content in the solid electrolyte material of Example 1 were measured by high-frequency inductively coupled plasma emission spectrometry. The molar ratio of Li:Al:I was calculated based on the contents of Li, Al, and I obtained from these measurement results. As a result, the solid electrolyte material of Example 1 had a molar ratio of Li:Al:I of 1:1:4 as with the molar ratio in the raw material powders.

### Evaluation of Ion Conductivity

FIG. 2 is a schematic view showing a compression molding dies 300 used for evaluation of the ion conductivity of a solid electrolyte material.

The compression molding dies 300 included a punch upper part 301, a die 302, and a punch lower part 303. The punch upper part 301 and the punch lower part 303 were both formed from electron-conductive stainless steel. The die 302 was formed from insulating polycarbonate.

The ion conductivity of the solid electrolyte material of Example 1 was measured using the compression molding dies 300 shown in FIG. 2 by the following method.

The powder of the solid electrolyte material of Example 1 (i.e., the powder 101 of the solid electrolyte material in FIG. 2) was loaded inside the compression molding dies 300 in a dry atmosphere having a dew point of −30° C. or less. A pressure of 300 MPa was applied to the solid electrolyte material of Example 1 inside the compression molding dies 300 using the punch upper part 301 and the punch lower part 303.

The punch upper part 301 and the punch lower part 303 were connected to a potentiostat (Princeton Applied Research, VersaSTAT4) equipped with a frequency response analyzer under application of the pressure. The punch upper part 301 was connected to the working electrode and the potential measurement terminal. The punch lower part 303 was connected to the counter electrode and the reference electrode. The impedance of a solid electrolyte material was measured by an electrochemical impedance measurement method at room temperature.

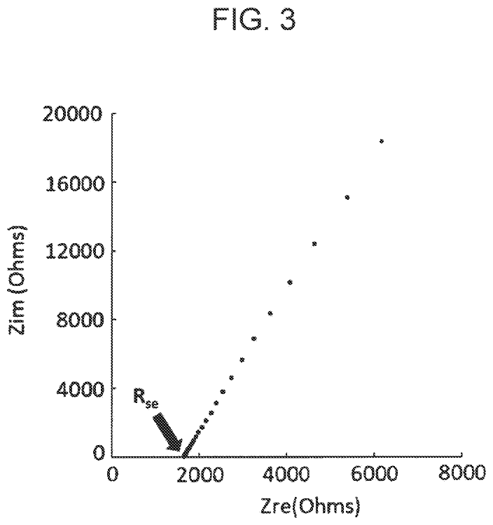

FIG. 3 is a graph showing a cole-cole plot obtained by impedance measurement of the solid electrolyte material of Example 1.

In FIG. 3, the real value of impedance at the measurement point where the absolute value of the phase of the complex impedance was the smallest was regarded as the resistance value of the solid electrolyte material to ion conduction. Regarding the real value, see the arrow R_{SE} shown in FIG. 3. The ion conductivity was calculated using the resistance value based on the following mathematical expression (3):

σ=(R_{SE}×S/t)⁻¹ (3).

Here, σ represents ion conductivity; S represents the contact area of a solid electrolyte material with the punch upper part 301 (equal to the cross-sectional area of the hollow part of the die 302 in FIG. 2); R_{SE} represents the resistance value of the solid electrolyte material in impedance measurement; and t represents the thickness of the solid electrolyte material (i.e., in FIG. 2, the thickness of the layer formed from the powder 101 of the solid electrolyte material).

The ion conductivity of the solid electrolyte material of Example 1 measured at 22° C. was 2.2×10⁻⁵ S/cm.

### X-Ray Diffraction Measurement

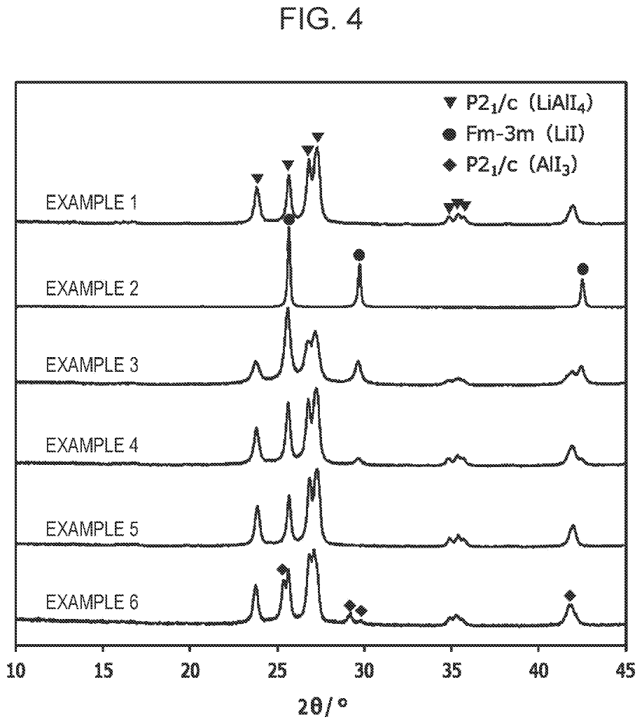

FIG. 4 is a graph showing an X-ray diffraction pattern of the solid electrolyte material of Example 1. The results shown in FIG. 4 were measured by the following method.

The solid electrolyte material of Example 1 was sampled in an airtight jig for X-ray diffraction measurement in a glove box in an argon atmosphere having a dew point of −60° C. or less. Subsequently, the X-ray diffraction pattern of the solid electrolyte material of Example 1 was measured using an X-ray diffractometer (Rigaku Corporation, MiniFlex 600). The X-ray diffraction pattern was measured by a θ-2θ method using Cu-Kα rays (wavelengths: 1.5405 angstrom and 1.5444 angstrom) as the X-ray source.

In the X-ray diffraction pattern of the solid electrolyte material of Example 1, there were peaks at 23.8°, 25.7°, 26.8°, 27.3°, 34.8°, 35.3°, 35.7°, and 42.0°. Accordingly, the solid electrolyte material of Example 1 contains a first crystal phase having a crystal structure belonging to P2₁/c. The angles of the observed diffraction peaks are shown in Table 2.

### Production of Battery

The solid electrolyte material of Example 1, Li₄Ti₅O₁₂, and a carbon fiber (VGCF) were prepared at a weight ratio of 65:30:5 in a dry argon atmosphere. These materials were mixed in a mortar. Thus, a mixture was obtained.

An argyrodite-type sulfide solid electrolyte Li₆PS₅Cl (80 mg), the solid electrolyte material (20 mg) of Example 1, the above mixture (15 mg), and VGCF (2 mg) were stacked in this order in an insulating tube having an inner diameter of 9.5 mm. A pressure of 740 MPa was applied to this laminate to form a solid electrolyte layer and a first electrode.

Subsequently, metal In foil, metal Li foil, and metal In foil were stacked in this order on the solid electrolyte layer. A pressure of 40 MPa was applied to this laminate to form a second electrode.

Subsequently, a current collector formed from stainless steel was attached to the first electrode and the second electrode, and a current collecting lead was attached to the current collector.

Finally, the inside of the insulating tube was isolated from the outside atmosphere using an insulating ferrule to seal the inside of the tube. Thus, a battery of Example 1 was obtained.

### Charge and Discharge Test

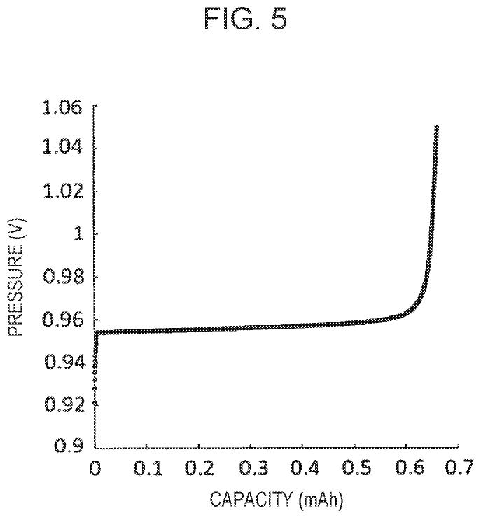

FIG. 5 is a graph showing the initial discharge characteristics of the battery of Example 1. The initial charge and discharge characteristics were measured by the following method.

The battery of Example 1 was placed in a thermostat of 80° C.

The battery of Example 1 was charged at a current density of 56 μA/cm² until the voltage reached 0.60 V. The current density corresponded to 0.05 C rate.

Subsequently, the battery of Example 1 was discharged at a current density of 56 μA/cm² until the voltage reached 1.05 V.

As the results of the charge and discharge test, the battery of Example 1 had an initial discharge capacity of 661 μAh.

### Examples 2 to 6

### Production of Solid Electrolyte Material

In Examples 2 to 6, LiI and AlI₃ were prepared as the raw material powders such that the molar ratio of LiI:AlI₃ was (1−b):b.

Solid electrolyte materials of Examples 2 to 6 were obtained as in Example 1 except the above matters. The values of b are shown in Table 1. The solid electrolyte materials of Examples can be represented by a compositional formula: Li_{1-b}Al_{b}I_{1+2b}.

### Evaluation of Ion Conductivity

The ion conductivities of the solid electrolyte materials of Examples 2 to 6 were measured as in Example 1. The measurement results are shown in Table 1.

### X-Ray Diffraction Measurement

The X-ray diffraction patterns of solid electrolyte materials of Examples 2 to 5 were measured as in Example 1.

FIG. 4 is a graph showing X-ray diffraction patterns of the solid electrolyte materials of Examples 2 to 5. The angles of observed diffraction peaks are shown in Table 2. In Table 2, the numbers shown in parentheses each represent the angle of a diffraction peak overlapping another diffraction peak.

### Charge and Discharge Test

Batteries of Examples 2 to 6 were obtained as in Example 1 using the solid electrolyte materials of Examples 2 to 6. The batteries of Examples 2 to 6 were well charged and discharged as in the battery of Example 1.

### Comparative Example 1

### Production of Solid Electrolyte Material

As the solid electrolyte material of Comparative Example 1, LiI was prepared.

The value of b is shown in Table 1.

### Evaluation of Ion Conductivity

The ion conductivity of the solid electrolyte material of Comparative Example 1 was measured as in Example 1. The measurement result is shown in Table 1.

TABLE 1

| | | | Ion conductivity |
|---|---|---|---|
| | Composition | b | (S/cm) |
| Example 1 | Li_{0.5}Al_{0.5}I₂ | 0.5 | 2.2 × 10⁻⁵ |
| Example 2 | Li_{0.99}Al_{0.01}I_{1.02} | 0.01 | 4.4 × 10⁻⁶ |
| Example 3 | Li_{0.67}Al_{0.33}I_{1.66} | 0.33 | 5.0 × 10⁻⁵ |
| Example 4 | Li_{0.55}Al_{0.45}I_{1.9} | 0.45 | 2.5 × 10⁻⁵ |
| Example 5 | Li_{0.45}Al_{0.55}I_{2.1} | 0.55 | 4.1 × 10⁻⁶ |
| Example 6 | Li_{0.33}Al_{0.67}I_{2.34} | 0.67 | 1.3 × 10⁻⁵ |
| Comparative | LiI | 0 | 3.2 × 10⁻⁶ |
| Example 1 | | | |

TABLE 2

| | | | Crystal |
|---|---|---|---|
| | | | structure |
| | Diffraction peak angle (°) | | of second |
| | First crystal phase | Second crystal phase | crystal phase |
| Exam- | 23.8, 25.7, 26.8, 27.3, | — | — |
| ple 1 | 34.8, 35.3, 35.7, 42.0 | | |
| Exam- | — | 25.7, 29.7, 42.4 | Fm-3m(LiI) |
| ple 2 | | | |
| Exam- | 23.7, (25.6), 26.7, 27.2, | (25.6), 29.6, 42.4 | Fm-3m(LiI) |
| ple 3 | 34.8, 35.4, 41.9 | | |
| Exam- | 23.8, (25.6), 26.8, 27.2, | (25.6), 29.6, 42.5 | Fm-3m(LiI) |
| ple 4 | 34.8, 35.3, 35.7, 41.9 | | |
| Exam- | 23.8, 25.7, 26.8, 27.3, | — | — |
| ple 5 | 34.8, 35.3, 35.7, 42.0 | | |
| Exam- | 23.7, 25.6, 26.8, 27.1, | 25.3, 29.1, 29.7, | P2₁/c(AlI₃) |
| ple 6 | 34.9, 35.3, 35.6, (41.8) | (41.8) | |

### Consideration

As obvious from Table 1, the solid electrolyte materials of Examples 1 to 6 have high ion conductivities of 4×10⁻⁶ S/cm or more at around room temperature. Accordingly, the solid electrolyte materials represented by the compositional formula (1) or (2) have high ion conductivities.

When the value of b is, for example, within a range of 0.2 or more and 0.48 or less, in particular, within a range of 0.33 or more and 0.45 or less, the solid electrolyte material has a further high ion conductivity.

In all Examples 1 to 6, the batteries were charged and discharged at room temperature.

As described above, the solid electrolyte material of the present disclosure is a material that can improve the lithium ion conductivity and is suitable for providing a battery that can be well charged and discharged.

The solid electrolyte material of the present disclosure is used in, for example, a battery (e.g., an all solid lithium ion secondary battery).

What is claimed is:

1. A solid electrolyte material represented by a following compositional formula (1):
Li₁₋ₐAlₐX₁₊₂ₐ (1)
wherein 0<a<1 (excluding a=0.5) is satisfied; and
X is at least one selected from the group consisting of Cl, Br, and I.

2. The solid electrolyte material according to claim 1, wherein
in the compositional formula (1), 0<a<0.5 is satisfied.

3. The solid electrolyte material according to claim 2, wherein
in the compositional formula (1), 0.01≤a≤0.45 is satisfied.

4. The solid electrolyte material according to claim 3, wherein
in the compositional formula (1), 0.33≤a≤0.45 is satisfied.

5. The solid electrolyte material according to claim 1, wherein
in the compositional formula (1), 0.5<a<1 is satisfied.

6. The solid electrolyte material according to claim 5, wherein
in the compositional formula (1), 0.55≤a≤0.67 is satisfied.

7. The solid electrolyte material according to claim 1, wherein
X includes I.

8. A solid electrolyte material comprising Li, Al, and X′, wherein
X′ is at least one selected from the group consisting of Cl, Br, and I, and
the solid electrolyte material includes a first crystal phase belonging to P2₁/c and a second crystal phase different from the first crystal phase.

9. The solid electrolyte material according to claim 8, wherein
the second crystal phase belongs to Fm-3m.

10. The solid electrolyte material according to claim 8, wherein
the second crystal phase belongs to C2/m or P2₁/c.

11. The solid electrolyte material according to claim 8, wherein
X′ includes I.

12. A battery comprising:
a positive electrode;
a negative electrode; and
an electrolyte layer disposed between the positive electrode and the negative electrode, wherein
at least one selected from the group consisting of the positive electrode, the negative electrode, and the electrolyte layer includes the solid electrolyte material according to claim 1.

13. A battery comprising:
a positive electrode;
a negative electrode; and
an electrolyte layer disposed between the positive electrode and the negative electrode, wherein
the electrolyte layer contains 20 mol % or more of a compound represented by a following compositional formula (2):
Li_{1-b}Al_{b}I_{1+2b} (2)
wherein 0<b<1 is satisfied.

14. The battery according to claim 13, wherein
the electrolyte layer contains 50 mol % or more of the compound.

15. The battery according to claim 13, wherein
the electrolyte layer consists of the compound.
